(19) United States
(12) Patent Application Publication
(10) Pub. No.: US 2002/0084628 A1
(43) Pub. Date: Jul. 4, 2002

(54) Multipurpose carrier

(76) Inventors: Michael D. Van Horn, Zimmerman, MN (US); Paul Schlough, Anoka, MN (US)

Correspondence Address: MERCHANT & GOULD PC, P.O. BOX 2903, MINNEAPOLIS, MN, 55402-0903, US

(21) Appl. No.: 09/754,002

(22) Filed: Jan. 3, 2001

(51) Int. Cl. B62B 7/12

(52) U.S. Cl. 280/648; 280/47.38

(57) ABSTRACT

A multipurpose carrier capable of transporting people and/or consumer goods is disclosed. The multipurpose carrier disclosed can be readily converted between first configuration (e.g., a stroller configuration) and a second configuration (e.g., a shopping cart configuration). The carrier comprises a rigid retaining module that is positionable between a first configuration (e.g., a stroller configuration) and a second configuration (e.g., a shopping cart configuration). The carrier also comprises a frame assembly supporting the retaining module. The frame assembly is constructed and arranged to support the retaining module such that the retaining module in the first configuration is offset from the retaining module in the second configuration. In one embodiment of the invention, the carrier also comprises a linkage arrangement pivotably securing the retaining module to the frame assembly. The linkage arrangement can be constructed and arranged to allow the retaining member to articulate between the first configuration and the second configuration.

### TECHNICAL FIELD

The present invention relates generally to a multipurpose carrier capable of transporting people and/or consumer goods and, more particularly, to a multipurpose carrier capable of transporting people and/or consumer goods that is readily convertible between stroller and shopping cart.

### BACKGROUND

Multipurpose carriers that combine one or more functions are known in the art. In particular, multipurpose carriers exist that can be used as strollers for transporting people and/or shopping carts for transporting consumer goods. Typically, for example, many existing multipurpose carriers provide a seat for supporting a passenger (e.g., a child, such as, an infant or toddler) when being used as a stroller and a receptacle for holding consumer goods when being used as a shopping cart.

Despite the increased functionality offered by existing multipurpose carriers, they are often cumbersome and difficult to use. For example, the seat used to support the passenger is typically rigidly affixed to the frame of the carrier. Thus, when the user or operator chooses to use the carrier as a shopping cart, a removable receptacle or other similar device must be attached to the carrier. In this configuration, the space available for holding the various consumer products is often limited by the shape of the seat and, thus, is not optimized for holding consumer goods or other packages.

Furthermore, because the seat used to support the passenger is rigidly affixed to the frame of the carrier, existing multipurpose carriers are often awkward when not being used for their primary function. For example, in a situation where the seat is rigidly affixed to the carrier at a low height relative to the ground, it can be difficult for the operator to load/unload consumer goods or other packages into the receptacle when the carrier is being used as a shopping cart. Conversely, in a situation where the seat is rigidly affixed to the carrier a high height relative to the ground, it can be difficult for a passenger to enter or exit the carrier without assistance.

Improvements in multipurpose carriers capable of transporting people and/or consumer goods are, therefore, sought.

### SUMMARY

In general terms, the present disclosure relates to a multipurpose carrier capable of transporting people and/or consumer goods. More particularly, the present disclosure relates to a multipurpose carrier capable of transporting people and/or consumer goods and further being readily convertible between a stroller and shopping cart. In one aspect of the invention, the carrier comprises a rigid retaining module that is positionable between a first configuration (e.g., a stroller configuration) and a second configuration (e.g., a shopping cart configuration). The carrier also comprises a frame assembly supporting the retaining module. The frame assembly is constructed and arranged to support the retaining module such that the retaining module in the first configuration is offset from the retaining module in the second configuration.

In this aspect, the frame assembly can comprise a first support member and a second support member. The first and second support members comprising the frame assembly are constructed and arranged to cooperatively support the retaining module. Furthermore, the second support member can include a crossbar extending between a first side of the carrier and a second side of the carrier opposite the first side. The crossbar is, therefore, capable of supporting a support surface of the retaining module when in the second configuration.

In another aspect of the invention, the carrier comprises a rigid retaining module, a frame assembly supporting the retaining module, and a linkage arrangement pivotably securing the retaining module to the frame assembly. The linkage arrangement can be constructed and arranged to allow the retaining member to articulate between a first configuration (e.g., the stroller configuration) and a second configuration (e.g., the shopping cart configuration).

In this aspect, the frame assembly comprises a first support member and a second support member. The first and second support members can be constructed and arranged to cooperatively support the retaining module. The second support member can include a crossbar extending between a first side of the stroller and a second side of the stroller opposite the first side. The crossbar is preferably constructed and arranged to support a second support surface of the retaining module when in the second configuration.

Further in this aspect, the linkage arrangement can comprise at least one linkage arm pivotably securing the retaining module to the frame assembly. More particularly, the linkage arrangement can comprise a first linkage arm that pivotably secures the retaining module to the frame assembly. Similarly, the linkage arrangement can comprise a second linkage arm that pivotably secures the retaining module to the frame assembly. Alternatively, the linkage arrangement can comprise a first pair of symmetrical linkage arms that pivotably secure the retaining module to the frame assembly. Similarly, the linkage arrangement can comprise a second pair of symmetrical linkage arms that pivotably secure the retaining module to the frame assembly.

Still further in this aspect, the first configuration of the carrier is vertically offset from the second configuration of the carrier. Likewise, the first configuration of the carrier is laterally offset from the second configuration of the carrier.

In yet another aspect of the invention, the carrier of the present disclosure comprises a retaining module, a frame assembly supporting the retaining module, and a linkage arrangement that pivotably secures the retaining module to the frame assembly. In this aspect, the frame assembly comprises a first support member and a second support member. The first and second support members of the frame assembly are constructed and arranged to cooperatively support the retaining module. Furthermore, the linkage arrangement pivotably secures the retaining module to the frame assembly and is constructed and arranged for articulating the retaining module between a first configuration and a second configuration. The linkage arrangement can comprise a first linkage arm that pivotably secures the retaining module to the second support member. Similarly, the linkage arrangement can comprise a second linkage arm that pivotably secures the retaining module to the second support member.

In this aspect, the second support member can include a crossbar extending between a first side of the carrier and a second side of the carrier opposite the first side. The crossbar is preferably constructed and arranged for to support a second support surface of the retaining module when in the second configuration.

Further in this aspect, the linkage arrangement can comprise a first pair of symmetrical linkage arms that pivotably secure the retaining module to the second support member. Similarly, the linkage arrangement can comprise a second pair of symmetrical linkage arms that pivotably secure the retaining module to the second support member.

Still further in this aspect, the first configuration of the carrier is vertically offset from the second configuration of the carrier. Likewise, the first configuration of the carrier is laterally offset from the second configuration of the carrier.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a multipurpose carrier in a first possible configuration in accordance with the principles of the present disclosure;

FIG. 2 is a side elevational view of the multipurpose carrier of FIG. 1 in accordance with the principles of the present disclosure;

FIGS. 3-6 are side elevational views of the multipurpose carrier of FIGS. 1 and 2 illustrating the various positions of the carrier as the carrier is converted from a first configuration to a second configuration in accordance with the principles of the present disclosure; and

FIG. 7 is a side elevational view of the multipurpose carrier of FIGS. 1 and 2 in a second possible configuration in accordance with the principles of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Various embodiments of the present invention will be described in detail with reference to the drawings, wherein like reference numerals represent like parts and assemblies throughout the several views. Reference to the various embodiments does not limit the scope of the present invention, which is limited only by the scope of the claims attached hereto.

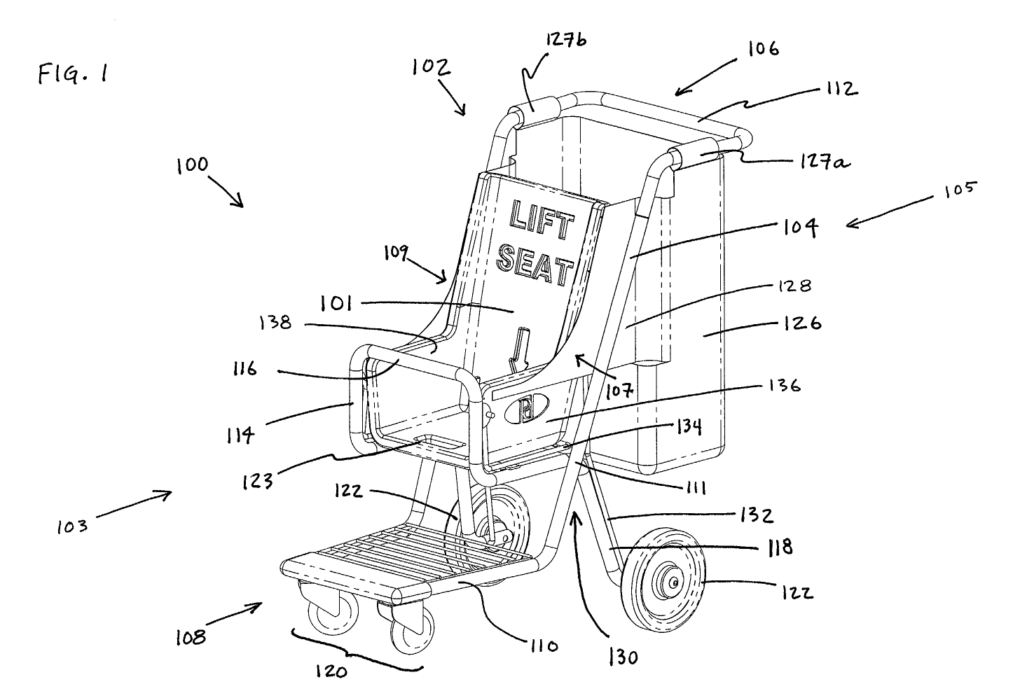

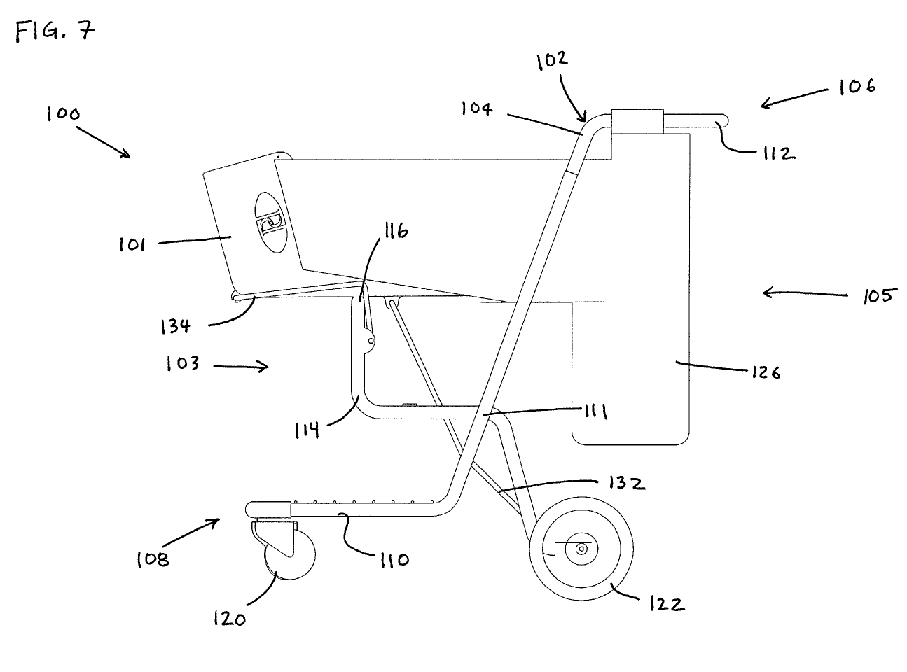

Now referring to FIG. 1, a multipurpose carrier 100 that is capable of transporting passengers and/or consumer goods is shown. In particular, the carrier 100 can be readily converted between at least a first configuration and a second configuration. In the first configuration (e.g., as shown in FIG. 1), the carrier 100 serves as a stroller or wheeled carrier and is capable of transporting passengers, such as, elderly adults, disabled persons, children, including infants or toddlers, or other persons requiring assistance when walking or traveling. In the second configuration (e.g., as shown in FIG. 7), the carrier 100 serves as a shopping cart and is capable of transporting consumer goods, such as, grocery products, household goods, or other similar products or packages. The carrier 100 has a front end portion 103, a rear end portion 105, a first side 107, and a second side 109 opposite the first side 107. Generally, the carrier 100 is symmetrical when viewed from the front and rear end portions 103, 105 as well as both the first and second sides 107, 109.

As illustrated in FIG. 1, the carrier 100 includes a retaining module 101. In the first configuration (e.g., the stroller), the retaining module 101 serves as a seat for the passenger being transported. In the second configuration (e.g., the shopping cart), the retaining module 101 serves as a receptacle that receives and carries the consumer goods being transported. As will be described in greater detail below, the retaining module 101 is selectively positionable between at least the first configuration and the second configuration, thereby, allowing the carrier 100 to be readily converted between a stroller and a shopping cart.

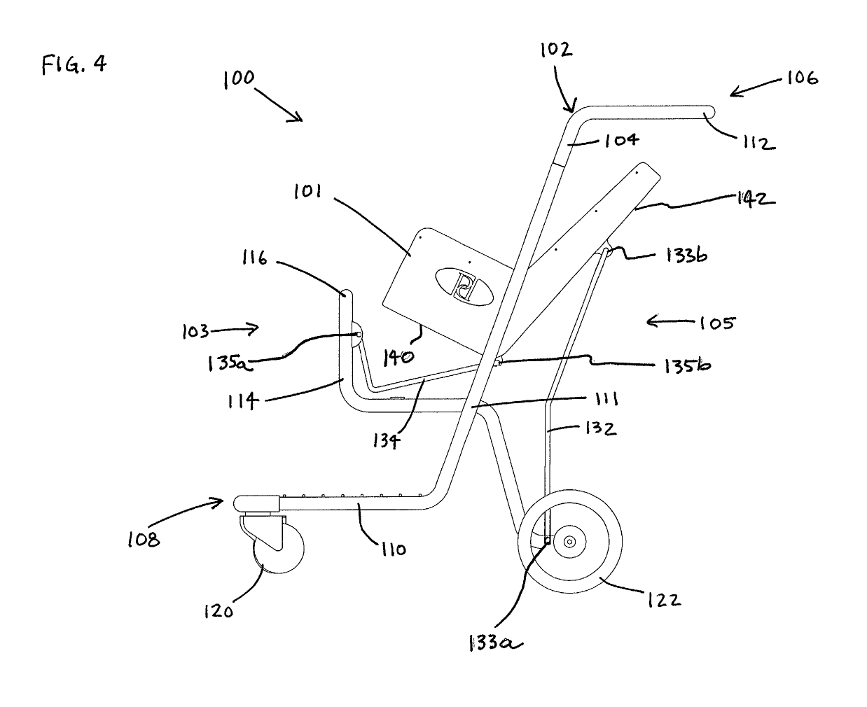

The retaining module 101 is generally L-shaped and includes a first sidewall 136, a second sidewall 138, a first support surface 140 (FIG. 4) and a second support surface 142 (FIG. 4). The first and second sidewalls 136, 138 secure the passenger within the retaining module 101 when the carrier 100 is used as a stroller. Similarly, the first and second sidewalls 136, 138 secure the consumer goods within the retaining module 101 when the carrier 100 is used as a shopping cart. As shown throughout the various views, the first support surface 140 is arranged substantially parallel to the ground when the carrier 100 is in the first configuration (e.g., the stroller). As a result, the weight or load disposed within the retaining module 101 is directed substantially perpendicular to the first support surface when in the first configuration. The second support surface 142 is arranged at an incline with respect to the first support surface 140. For example, the second support surface 142 is inclined with respect to the first support surface at an angle between at least about 90 degrees and no greater than about 150 degrees, typically about 105-135 degrees, and in preferred embodiments about 115-120 degrees. As shown in FIG. 7, the second support surface 142 is arranged substantially parallel to the ground when the carrier 100 is in the second configuration (e.g., the shopping cart).

Referring again to FIG. 1, the carrier 100 also includes a frame assembly 102 for supporting the retaining module 101. In the embodiment illustrated in FIG. 1, the frame assembly 102 comprises a first support member 104 and a second support member 114. The first and second support members 104, 114 are preferably substantially symmetrical along the first and second sides 107, 109 of the carrier 100. Moreover, the first and second support members 104, 114 are generally constructed and arranged to cooperatively support the retaining module 101. By “cooperatively support,” it is generally meant that the first and second support members 104, 114 cooperate to support any weights or loads placed within the retaining module 101 during use, such as, a passenger when the carrier 100 is being used as a stroller or, alternatively, one or more packages when the carrier 100 is being used as a shopping cart. In one possible embodiment, the frame assembly 102 can comprise generally tubular elements that are manufactured from a lightweight metallic material or composite, such as, a steel alloy, an aluminum alloy, or any other similar material capable or supporting the weight of the carrier 100 during use. Alternatively, the frame assembly 102 can be manufactured from a lightweight, polymeric material, such as, a high density polyurethane, or any other similar nonmetallic material capable of supporting the weight of the carrier 100 during use.

In the illustrated embodiment, the first support member 104 is generally S-shaped and can be rigidly attached to the second support member 114. In particular, the first support member 104 can be rigidly attached to the second support member 114 at a first node or intersection 111 at the first side 107 of the carrier 100. Similarly, the first support member 104 can be rigidly attached to the second support member 114 at a second node or intersection (not shown) opposite the first node 111 at the second side 109 of the carrier. By “rigidly attached,” it is generally meant that the first support member 104 is secured to the second support member 114 using one or more conventional fasteners, such as, bolts, rivets, or other similar fasteners capable of rigidly securing the first support member 104 to the second support member 114. Alternatively, the first support member 104 can be welded or otherwise permanently secured to the second support member 114. In so doing, the frame assembly 102 comprises a rigid frame assembly. In an alternative embodiment, however, one having ordinary skill in the art will readily appreciate that the frame assembly 102 can comprise a collapsible frame assembly. For example, the first support member 104 can be pivotably attached or secured to the second support member 114 at the first node 109 and the second node (not shown). In so doing, the frame assembly 102 can be collapsible, thereby, allowing the carrier 100 to be easily stored and/or transported in an automobile or other similar vehicle.

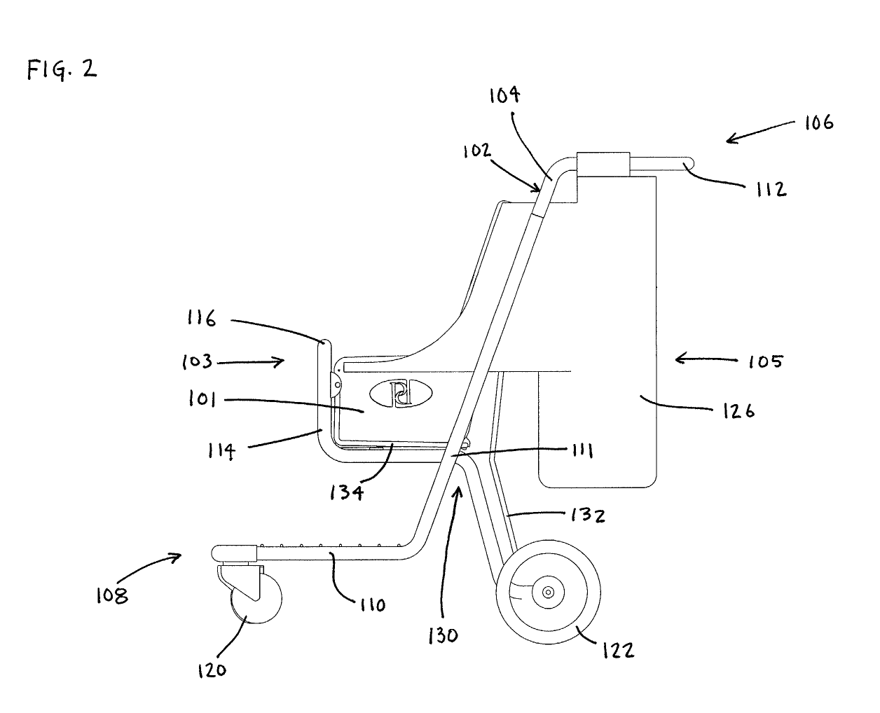

The first support member 104 has an upper end 106 and a lower end 108. At the upper end 106, the first support member 104 defines a handle portion 112. In the embodiment illustrated in FIGS. 1 and 2, the handle portion 112 extends rearwardly away from the retaining module 101 to provide a suitable area for gripping or handling the carrier 100 during use. By “rearwardly away,” it is generally meant that in the orientation shown in FIG. 1, the handle portion 112 extends towards the back and away from the carrier 100. At the lower end 108, the first support member 104 defines a platform 110 comprising a series of parallel and evenly spaced apart rod-like members. In the embodiment illustrated in FIG. 1, the platform 110 is situated and arranged below the retaining module 101 and is generally constructed and arranged to support consumer goods or packages while the carrier 100 is being used as either a stroller or a shopping cart.

The second support member 114 is also generally S-shaped. Towards the front end 103 of the carrier 100, the second support member 114 extends from the first side 107 of the carrier 100 to the second side 109 of the carrier 100 to define a crossbar 116. The crossbar 116 can be used to restrain the passenger within the retaining member 101 while the carrier is used as a stroller. Alternatively, the crossbar 116 can be used to support the retaining member 101 as will be described in greater detail below. Towards the rear end 105 of the carrier 100, the second support member 114 defines first and second leg members 118. The first and second leg members 118 provide stability and support for the carrier 100 during use.

A plurality of wheels or casters can be provided beneath the carrier 100 to facilitate movement. In particular, a first set of casters 120 can be positioned at or near the lower end 108 of the first support member 104 towards the front 103 of the carrier 100. Similarly, a second set of casters 122 can be positioned at or near the leg members 118 of the second support member 114 towards the rear 105 of the carrier 100. Furthermore, in the illustrated embodiment, the second set of casters 122 towards the rear 105 of the carrier 100 can be larger than the first set of casters 120 towards the front 103 of the carrier 100 to improve the handling of the carrier 100.

A bag or container 126 is located at or near the rear 105 of the carrier 100. In the illustrated embodiment, the container 126 is draped from the handle portion 112 using first and second tabs or support members 127a, 127b. Preferably, the container 126 is manufactured from a flexible material, such as, fabric, mesh, or other similar material. However, one skilled in the art will readily appreciate that the container 126 can be manufactured from any material suitable for receiving and carrying consumer goods or packages. As with the platform 110, the bag or container 126 can be used to receive or carry consumer goods or packages while the carrier 100 is being used as either a stroller or a shopping cart.

The container 126 also includes first and second wing or side elements 128 that extend from the main compartment of the container 126 towards the retaining member. The first and second wing elements 128 can be constructed and arranged to conform to the contour of the retaining member 101 as shown in FIGS. 1 and 2. Accordingly, the first and second wing elements 128 allow the container 126 to be attached to the retaining module 101. The container 126 can be attached to the retaining module 101 using any suitable mechanism or method of attachment. For example, the container 126 can be securably attached to the retaining module 101 using bolts, rivets, or other similar fastening devices. In an alternative embodiment, however, the container 126 can be removably attached to the retaining module 101 to facilitate cleaning of the container 126 when the carrier 100 is not in use. For example, the container 126 can be removably attached to the retaining module 101 using a collection of snaps or button fasteners, hook and loop fasteners, or other similar removable fastening devices. In either case, the container 126 can be attached at the first and second sidewalls 136, 138 of the retaining module 101. In particular, the first and second wing elements 128 can be attached at the first and second sidewalls 136, 138. When in the first configuration as shown in FIG. 1, the first and second wing elements 128 are relaxed. Conversely, when in the second configuration as shown in FIG. 7, the first and second wing elements 128 are taut and provide an extension of the first and second sidewalls 136, 138 when the carrier 100 is being used as a shopping cart. Additionally, the container 126 can be attached to the second support surface 142.

In the illustrated embodiment as described above, the container 126 defines a single compartment for receiving consumer goods or packages. However, one skilled in the art will readily appreciate that the container 126 can comprise one or more separate compartments attached to the carrier 100. For example, the container 126 can comprise a first compartment attached to the handle portion 112 of the carrier as discussed above. Additionally, the container 126 can comprise a second and distinct compartment attached to the first support member 104 in front of the first compartment.

As discussed above, the retaining module 101 is positionable between at least a first configuration (e.g., a stroller) and a second configuration (e.g., a shopping cart). In one possible embodiment, the retaining module 101 can be manually positioned between the first and second configurations within the frame member 102. In an alternative embodiment, a linkage arrangement 130 can be provided to pivotably secure the retaining module 101 to the frame assembly 102. In particular, the linkage arrangement 130 is constructed and arranged for articulating the retaining module 101 between a first configuration and a second configuration. As discussed above, in the first configuration (e.g., as shown in FIG. 1), the retaining module 101 serves as a stroller or wheeled carrier for transporting passengers. Conversely, in the second configuration (e.g., as shown in FIG. 8), the retaining module 101 serves as a receptacle or basket that receives and carries the consumer goods being transported.

While many embodiments of the linkage arrangement 130 are contemplated, in one possible embodiment, the linkage arrangement 130 comprises at least one linkage arm pivotably securing the retaining module 101 to the frame assembly 102. In the illustrated embodiment, the linkage arrangement 130 includes a first linkage arm 132 pivotably securing the retaining module 101 to the second support member 114 and a second linkage arm 134 pivotably securing the retaining module 101 to the second support member 114. Moreover, one skilled in the art will readily appreciate that the multipurpose carrier 100 of the present disclosure can be implemented and operated using linkage arms having a variety of shapes, configurations, or lengths. For example, the first and second linkage arms 132, 134 can comprise a first pair of symmetrical linkage arms that pivotably secure the retaining module 101 to the second support member 114. Similarly, the second linkage arm 134 can comprise a second pair of symmetrical linkage arms that pivotably secure the retaining module 101 to the second support member 104. Still yet, the lengths of the first and second linkage arms 132, 134 can be varied in order to achieve the desired degree of articulation about the frame assembly 102.

As can be readily seen in FIG. 4, the first linkage arm 132 is pivotably secured to the second support surface 142 of the retaining module 101 at a first pivot position 133b. Similarly, the second linkage arm 134 is pivotably secured to the first support surface 140 of the retaining module 101 at a second pivot position 135b. In the illustrated embodiment, the second pivot position 135b is generally defined at the intersection of the first and second supporting surfaces 140, 142. However, one skilled in the art will readily appreciate that the location of first and second pivot positions 133b, 135b can be varied in order to achieve the desired degree of articulation.

In addition to being pivotably secured to the retaining member 101, the first and second linkage arms 132, 134 are also pivotably or hingedly secured to the frame assembly 102. In particular, the first linkage arm 132 is pivotably secured to the leg members 118 of the second support member 114 at a first frame pivot position 133a. Similarly, the second linkage arm 134 is pivotably secured to the second frame member 114 at a second frame pivot position 135a.

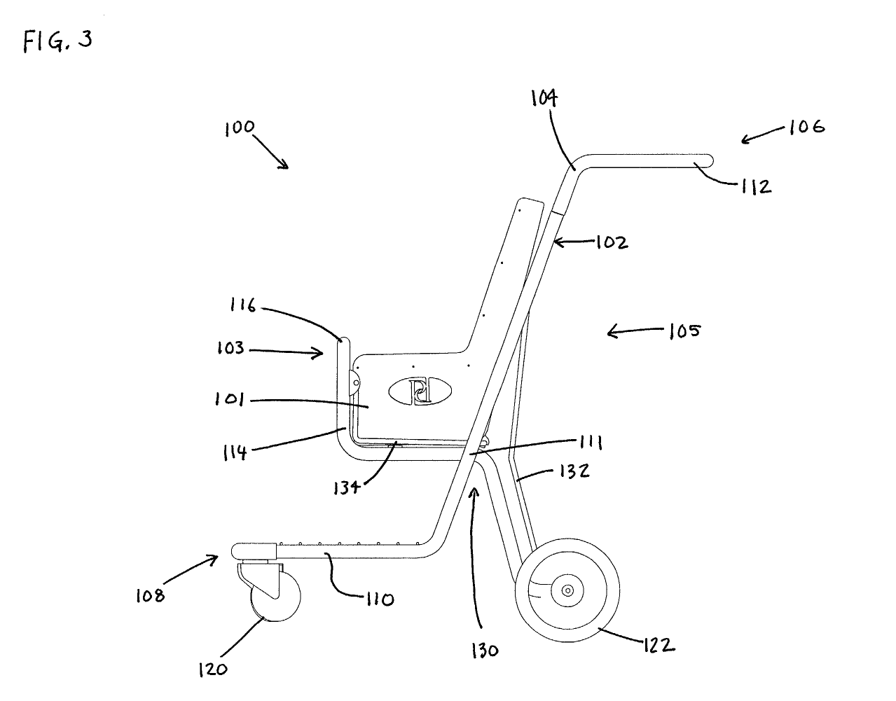

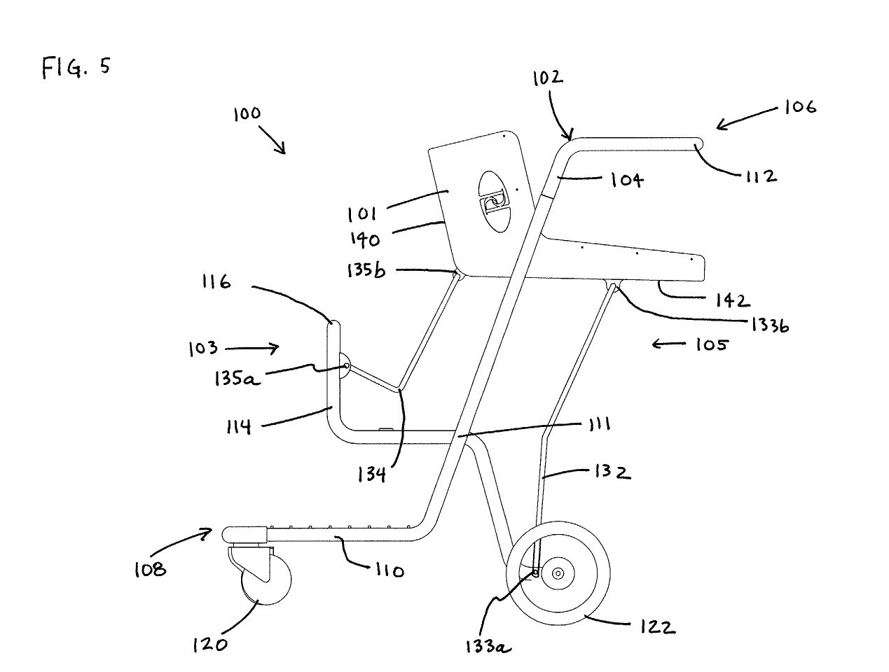

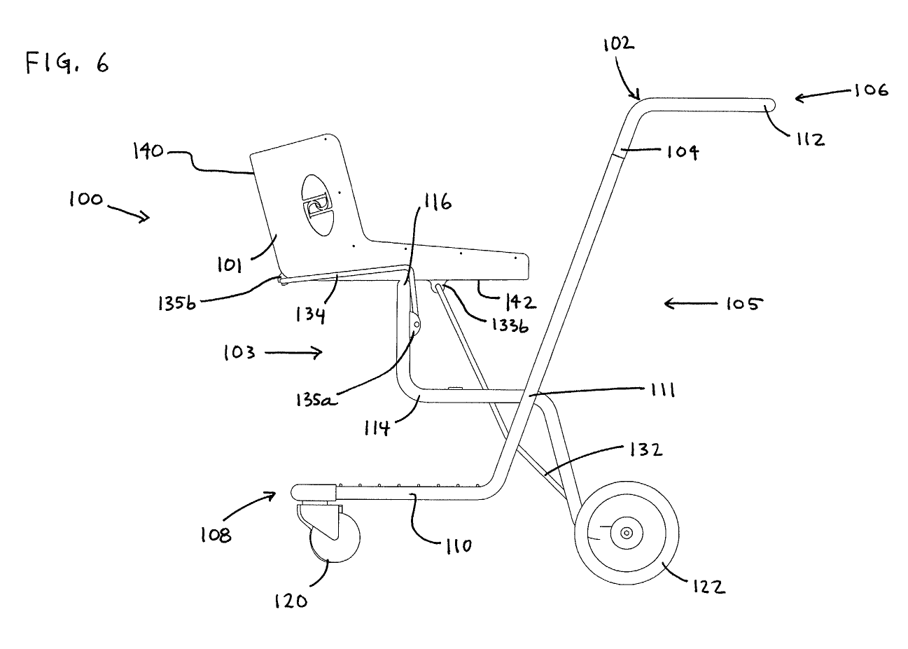

The operation of the linkage arrangement 130 will now be described in connection with FIGS. 3-7. It should be noted that the container 126 is not shown attached to the carrier 100 in FIGS. 3-7 for illustrative purposes only. In fact, the container 126 can remain attached to the carrier 100 as it is converted from a first configuration to a second configuration. When the operator decides to convert the carrier 100 from a stroller to a shopping cart, the operator can lift up on the retaining module 101 using a handle 123 (FIG. 1). In so doing, the retaining module 101 is articulated or rotated upwards and towards the rear 105 of the carrier 100 as shown in FIGS. 4 and 5. As the retaining module 101 reaches the apex or maximum articulation or extension of the first and second linkage arms 132, 134, the second support surface 142 of the retaining module 101 is arranged substantially parallel to the ground. The conversion of the carrier 100 can be completed by forwardly advancing the retaining module 101 until the second support surface 142 rests on the crossbar 116 as shown in FIG. 6.

As discussed above, the linkage arrangement 130 pivotably secures the retaining module 101 to the frame assembly 102 such that the retaining module 101 can articulate between the first configuration and the second configuration. As can be seen from FIGS. 3-7, the retaining module does not rotate about a common axis of rotation. Therefore, the retaining module 101 in the first configuration is vertically and laterally offset from the retaining module in the second configuration. By “vertically offset,” it is generally meant that the center of gravity of the retaining module 101 in the first configuration is positioned lower (e.g., relative to the ground) than the center of gravity of the retaining module 101 in the second configuration. Likewise, by “laterally offset,” the center of gravity of the retaining module 101 in the second configuration is positioned further forward (e.g., relative to the front 103 of the carrier 100) than the center of gravity of the retaining module 101 in the first configuration.

Accordingly, when being used as a seat (e.g., in the first or stroller configuration), the retaining module 101 is positioned at an acceptable height for transporting passengers. Egress and ingress into the carrier is, therefore, less awkward and can be done with minimal assistance. Similarly, when being used as a container or basket, the retaining modules 101 is positioned at an acceptable height for receiving and transporting consumer goods. Therefore, the operator can load or unload the consumer goods with minimal risk to injury.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

The claimed invention is:

1. A carrier being readily convertible between a stroller and shopping cart, comprising:
(a) a rigid retaining module being positionable between a first configuration and a second configuration; and
(b) a frame assembly supporting the retaining module; the frame assembly being constructed and arranged to support the retaining module such that the retaining module in the first configuration is offset from the retaining module in the second configuration.

2. The carrier according to claim 1, wherein the frame assembly the frame assembly comprises a first support member and a second support member; the first and second support members being constructed and arranged to cooperatively support the retaining module.

3. The carrier according to claim 2, wherein the second support member includes a crossbar extending between a first side of the carrier and a second side of the carrier opposite the first side; the crossbar being constructed and arranged for supporting a support surface of the retaining module when in the second configuration.

4. The carrier according to claim 1, wherein the first configuration is vertically offset from the second configuration.

5. The carrier according to claim 1, wherein the first configuration is laterally offset from the second configuration.

6. A carrier being readily convertible between a stroller and shopping cart, comprising:
(a) a rigid retaining module;
(b) a frame assembly supporting the retaining module; and
(c) a linkage arrangement pivotably securing the retaining module to the frame assembly; the linkage arrangement being constructed and arranged for articulating the retaining module between a first configuration and a second configuration.

7. The carrier according to claim 6, wherein the frame assembly comprises a first support member and a second support member; the first and second support members being constructed and arranged to cooperatively support the retaining module.

8. The carrier according to claim 7, wherein the second support member includes a crossbar extending between a first side of the carrier and a second side of the carrier opposite the first side; the crossbar being constructed and arranged for supporting a support surface of the retaining module when in the second configuration.

9. The carrier according to claim 6, wherein the linkage arrangement comprises at least one linkage arm pivotably securing the retaining module to the frame assembly.

10. The carrier according to claim 9, wherein the linkage arrangement further comprises:
(a) a first linkage arm pivotably securing the retaining module to the frame assembly; and
(b) a second linkage arm pivotably securing the retaining module to the frame assembly.

11. The carrier according to claim 9, wherein the linkage arrangement further comprises:
(a) a first pair of symmetrical linkage arms pivotably securing the retaining module to the frame assembly; and
(b) a second pair of symmetrical linkage arms pivotably securing the retaining module to the frame assembly.

12. The carrier according to claim 6, wherein the first configuration is vertically offset from the second configuration.

13. The carrier according to claim 6, wherein the first configuration is laterally offset from the second configuration.

14. The carrier according to claim 6, wherein the carrier further comprises a removable container situated at the rear of the carrier.

15. A carrier being readily convertible between a stroller and shopping cart, comprising:
(a) a retaining module;
(b) a frame assembly supporting the retaining module; the frame assembly comprising:
(i) a first support member and a second support member; the first and second support members being constructed and arranged to cooperatively support the retaining module; and
(c) a linkage arrangement pivotably securing the retaining module to the frame assembly; the linkage arrangement being constructed and arranged for articulating the retaining module between a first configuration and a second configuration; the linkage arrangement comprising:
(i) a first linkage arm pivotably securing the retaining module to the second support member; and
(ii) a second linkage arm pivotably securing the retaining module to the second support member.

16. The carrier according to claim 15, wherein the retaining module is rigid.

17. The carrier according to claim 15, wherein the second support member includes a crossbar extending between a first side of the carrier and a second side of the carrier opposite the first side; the crossbar being constructed and arranged for supporting a rearward portion of the retaining module when in the second configuration.

18. The carrier according to claim 15, wherein the linkage arrangement further comprises:
(a) a first pair of symmetrical linkage arms pivotably securing the retaining module to the second support member; and
(b) a second pair of symmetrical linkage arms pivotably securing the retaining module second support member.

19. The carrier according to claim 15, wherein the first configuration is vertically offset from the second configuration.

20. The carrier according to claim 15, wherein the first configuration is laterally offset from the second configuration.

21. The carrier according to claim 15, wherein the carrier further comprises a removable container situated at the rear of the carrier.
